(19) United States
(12) Patent Application Publication
(10) Pub. No.: US 2022/0356774 A1
(43) Pub. Date: Nov. 10, 2022

(54) Extreme Temperature Isolation Packer and Deployment System

(71) Applicant: Downhole Emerging Technologies, LLC, Houston, TX (US)

(72) Inventors: Tingji Tang, Houston, TX (US); Ken Havlinek, Houston, TX (US); Sharath Kolachalam, Sugar Land, TX (US)

(73) Assignee: Downhole Emerging Technologies, LLC, Houston, TX (US)

(21) Appl. No.: 17/662,229

(22) Filed: May 5, 2022

Related U.S. Application Data
(60) Provisional application No. 63/201,624, filed on May 6, 2021.

(51) Int. Cl. E21B 23/06; E21B 33/124

(52) U.S. Cl. CPC E21B 23/06; E21B 33/124

(57) ABSTRACT

An isolation system contains an isolation packer and a setting tool. The isolation packer comprises an inner mandrel, an expandable sealing around the inner mandrel, the expandable sealing includes a center sealing element, the outer diameter of the center sealing element in a relaxed state is larger than the outer diameter in a stretched state. The isolation packer further comprises an actuator to stretch the expandable sealing. the setting tool comprises a motor, a set of gear reducer, and an adapter, the adapter comprises a plurality of detents having ability to couple with the actuator when the adapter rotate anticlockwise and to decouple from the connector when the adapter rotate clockwise. The adapter also comprises a plurality of holes to receive shear screws.

### CROSS-REFERENCE TO RELATED APPLICATIONS

This application claims the benefit to U.S. Provisional Application No. 63/201,624 filed on May 6, 2021, the contents of which are incorporated by reference in its entirety.

### FIELD

The disclosure relates generally to downhole tools. The disclosure relates specifically to isolation packers rated to high temperature geothermal conditions.

### BACKGROUND

Geothermal energy is one of the leading renewable sources of environmentally-friendly power generation. It involves using the earth's stored thermal energy to super heat water, which can then be used to directly heat homes or generate electricity. Traditionally, geothermal electric plants have been built on the edges of tectonic plates where high temperature geothermal resources are available near the surface. Recent improvements in drilling and extraction technology have enabled the creation of geothermal power plants in areas where the thermal resources lie deep under the surface.

Geothermal projects pose challenges for safety and reliability because of the high pressure and high temperature of wells. These conditions have resulted in geothermal wells costing much more than oil and gas wells of comparable depths. The main challenge relating to geothermal wells is the temperature—which is often twice that of oil and gas wells—posing a serious challenge to the integrity of cement during setting, and therefore also the integrity of the well. Therefore, a zonal isolation and flow control system for an extremely high temperature (up to 400° C.), high differential pressure (up to 10,000 psi) geothermal well is needed. The system needs to be capable of maintaining a high-quality seal for long durations (estimated up to one year), but also be easily retrievable, ideally without the need for additional milling or drilling.

Inflatable packers are sometimes used to isolate a specific section of the wellbore for injection tests, fluid sampling, or other diagnostics. In this situation, some kind of logging or sampling tool must be run through the packer into the zone below it. Current packers either do not meet the extreme temperature requirement, cannot survive downhole for at least one year, and/or are not easily retrievable. Examples of the current commercially available packers include all-metal systems and elastomeric packer systems. All-metal systems are not easily deployable. They are either welded in place or covered with cement and are very difficult to retrieve/remove. Elastomeric packer systems can not be rated to high temperatures for the length of time required by geothermal wells.

It would be advantageous to provide the industry with a new high-quality packer and a very-high-force setting tool. Both devices would likely find expanded use beyond geothermal and other completions throughout the industry.

### SUMMARY

In accordance with the teachings of the present invention, an isolation system and method for isolating a specific section of a wellbore are provided that maintain a high-quality seal in high pressure and high temperature of wells.

In one aspect, the invention provides an isolation system contains at least two separate components. The first component is the isolation packer. It is nearly all metal and is originally machined such that the outer sleeve has an outer diameter that is preferably larger than the inner diameter of the wellbore casing that it will seal within. In an embodiment, the outer sleeve outer diameter is slightly smaller than the inner diameter of the wellbore casing that it will seal within. In an embodiment, the isolation packer will include ceramic teeth. In an embodiment, the isolation packer will comprise elastomeric seal components and metal rings to enhance the packer's sealing capabilities.

In a preferred embodiment, the isolation packer comprises an inner mandrel, an expandable sealing around the inner mandrel, the expandable sealing is formed by integration of an upper sealing element, a center sealing element, and a lower sealing element, the center sealing element is located between the upper sealing element and the lower sealing element, the center sealing element has an outer diameter, the outer diameter in a relaxed state is larger than the outer diameter in a stretched state.

The isolation packer further comprises an actuator to stretch the expandable sealing. The actuator has threads engaging with the inner mandrel assembly, the actuator moves along a longitudinal axis of the mandrel when rotating the actuator, the actuator comprises a connector.

The isolation packer further comprising a lower sleeve and an upper sleeve rigidly connected to the expandable sealing. the lower sleeve connects the expandable sealing to the inner mandrel, the upper sleeve connects the expandable sealing to the actuator.

To retrieve the isolation packer, a second component, a high force rotary setting tool can be connected to the packer, the setting tool comprises a motor, a set of gear reducer, and an adapter, the adapter comprises a plurality of detents having ability to couple with the connector when the adapter rotate anticlockwise and to decouple from the connector when the adapter rotate clockwise. The adapter also comprises a plurality of holes to receive shear screws.

In one aspect, the invention provides s method to deploy the isolation packer into a wellbore. In an embodiment, prior to run-in-hole, the isolation packer is pre-stretched such that the outer diameter is reduced enough to fit within the wellbore casing without risk of getting stuck while running-in-hole or while pulling-out-of-hole. After run-in-hole, this pre-stretch is released and the packer possibly obtains an initial set. In an embodiment, additional force from the high force rotary setting tool, the second component of this disclosure, can then be applied as needed.

In a preferred embodiment, deploying the isolation packer into a wellbore includes the steps: providing an isolation packer in the relaxed state; coupling the adapter with the connector and rotating anticlockwise the adapter to stretch the expandable sealing; arranging the shear screws through the first holes of the connector and the second holes of the adapter to connect the setting tool 200 and the isolation packer; moving the isolation system down to a desired depth of a casing, rotating clockwise the adapter to relax the expandable sealing; continuing to rotate clockwise the adapter until the shear screws are sheared; and retrieving the setting tool from the casing.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 illustrates a typical tool string and surface system;

FIG. 2 illustrates a perspective view of an isolation packer assembly in accordance with the described embodiments;

FIG. 3 illustrates a cross section view of the isolation packer assembly;

FIG. 4 illustrates a cross section view of the isolation packer assembly prior to run-in-hole and after being pre-stretched;

FIG. 5 illustrates a cross section view of the isolation packer assembly being run-in-hole;

FIG. 6 illustrates a cross section view of the isolation packer system relaxing after the pre-stretch has been released;

FIG. 7 illustrates a cross section view of the isolation packer system being additionally compressed and expanded by the setting tool;

FIG. 8 illustrates a graphical display of sleeve force vs. time of the setting operation;

FIG. 9 illustrates an embodiment of the high force rotary setting tool;

FIG. 10 illustrates an embodiment of how the setting tool can be connected to the isolation packer; and

FIG. 11 illustrates an embodiment of how the setting tool can reduce the output shaft speed in exchange for output force.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 11th Edition.

In the following description of the embodiments of the disclosure, “above”, “upper”, “upward”, “top” and similar terms refer to a direction toward the earth's surface along a wellbore, and “below”, “lower”, “downward”, “bottom” and similar terms refer to a direction away from the earth's surface along the wellbore.

The present disclosure provides an extreme temperature isolation tool (packer) (E-TIP) and corresponding setting tool. One feature of the isolation packer which distinguishes it from prior art packers, for example, is that the E-TIP has an all metal sealing surface which can survive extreme temperatures & corrosive downhole conditions for long periods of time. Other features of one embodiment of the isolation packer include requiring no additional force downhole to gain initial “set” once at depth, since the packer is pre-loaded prior to run-in-hole (RIH) in a stretched position, which allows it to fit into the casing. Another embodiment of the isolation packer would require additional force to gain initial “set” once at depth. Once this pre-load is released at depth, the packer relaxes and with additional force from the setting tool will lock in place.

In one embodiment, the packer includes an expandable sealing element coupled with an inner mandrel assembly. The expandable sealing element is made of metal and comprises a section that extends in a radially outward direction when the expandable sealing element is in a relaxed state. In the original relaxed state, the outer diameter of the expandable sealing element is machined to be close in size to the inner diameter of the wellbore casing, either slightly larger or slightly smaller, and the packer will not easily fit into the well and run without risk of getting stuck in this original relaxed machined state. To deploy the packer into the casing, the expandable sealing element can be elastically stretched such that the outer diameter of the expandable sealing element is reduced with enough clearance to safely run-in-hole without risk of getting stuck. Once at the desired depth, the tension on the expandable sealing element is released and the expandable sealing element returns to its original shape. With additional compression force from the setting tool, the expandable sealing element engages the casing wall and locks the expandable sealing element in place within the casing.

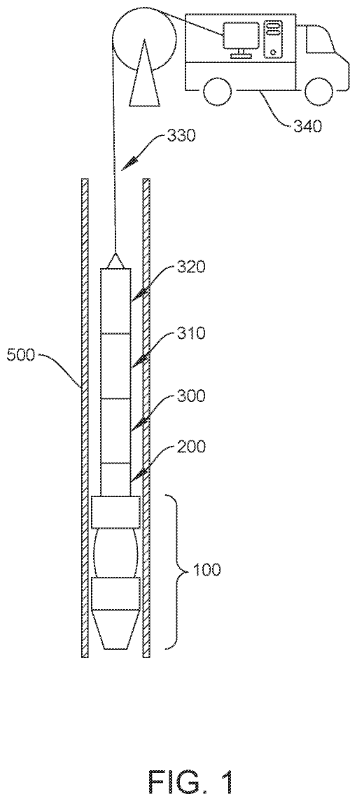

In some embodiments, the isolation packer is deployed into a wellbore during various operations throughout the life of the well. In a preferred embodiment, the setting tool and isolation packer systems are deployed using a conventional wireline configuration. Referring generally to FIG. 1, an isolation packer 100 can be deployed in a casing 500 through an acquisition system 340. The acquisition system 340 is a platform for raising and lowing a cable system 330 in the casing to locate the packer 100 in a desired position, and the cable system 330 can couple various other components, such as telemetry 320, electronics 310, a power supply 300, and a setting tool 200 which can help to arrange the packer 100 in the casing 500.

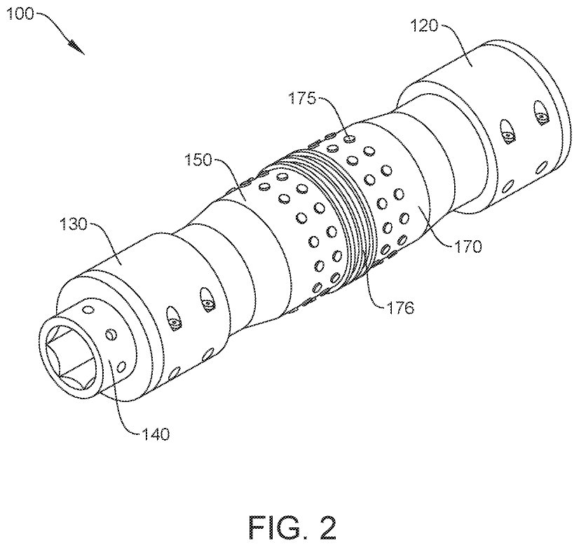

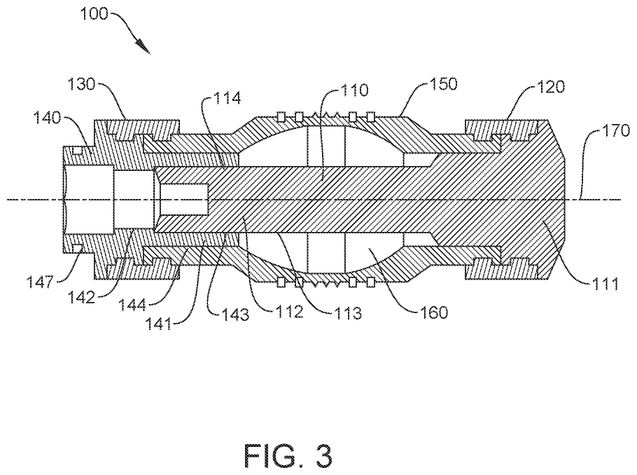

FIG. 2 and FIG. 3 illustrate an embodiment of isolation packer 100. The isolation packer 100 comprises an inner mandrel assembly 110 with a longitudinal axis 170, an expandable sealing element 150 is disposed around the inner mandrel assembly 110, the sealing 150 is formed by the integration of an upper sealing element 153, a center sealing element 151, and a lower sealing element 152, wherein the center sealing element 151 is located between the upper sealing element 153 and the lower sealing element 152. Rows of teeth 175 can be present on the outer circumference of the isolation packer. The center sealing element 151, can have an outer diameter similar to the diameter of well casing 500 in a relaxed state, either slightly smaller, slightly larger or equal to, and can be stretched along the longitudinal axis 170 of the mandrel 100 and radially shrink in order to safely run in the well casing 500 without risk of getting stuck.

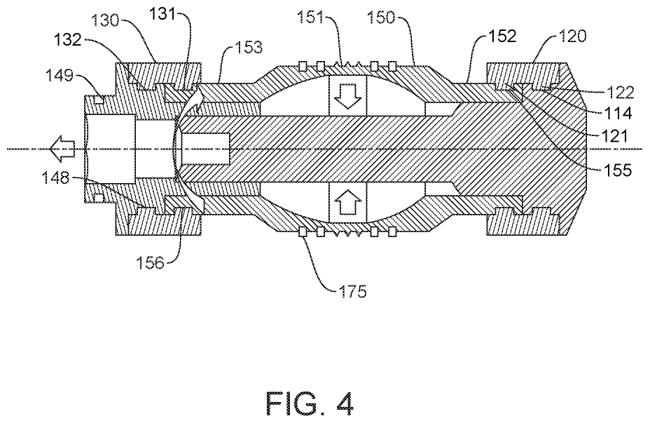

In an embodiment, the expandable sealing element 150 is formed of metal that can survive extreme temperatures and corrosive downhole conditions for long periods of time and has sufficient elasticity that does not exceed material stress/strain limits yet can obtain a sufficient sealing surface and holding (anti-slip) force for the specified casing. In an embodiment, the metal can be stainless steel or similar materials such as non-stainless alloys, aluminum, titanium, nickel alloys, manganese alloy steel or other high strength metal. In an embodiment, the center sealing element 151 includes a set of teeth 175 as an additional anti-slip feature on the surface. (FIG. 4) The center sealing element 151 further includes a plurality sealing rings 176 to overcome surface roughness on the inner surface of the casing and assist with creating a solid seal. In a preferred embodiment, the teeth 175 are ceramic.

In order to stretch expandable sealing element 150, the isolation packer provides lower sleeve 120 and upper sleeve 130 rigidly connected to expandable sealing element 150, an actuator 140 is coupled to the upper sleeve 130 and can move along the longitudinal axis 170 of the mandrel 100 to stretch expandable sealing element 150.

The lower sleeve 120 is located at the lower end 111 of the inner mandrel assembly 110 and rigidly connects the lower sealing element 152 to the lower end 111. Specifically, the lower sleeve 120 has two lugs 121, 122 projected from the inner surface thereof, and correspondingly, the inner mandrel assembly 110 has a slot 114 on the outer surface of the lower end 111 and the lower sealing element 152 has a slot 155 to engage the two lugs 121, 122 respectively, such that the expandable sealing element 150 cannot move with respect to the inner mandrel assembly 110, that is, expandable sealing element 150 can neither move linearly along the longitudinal axis 170 of the mandrel 100 nor rotate around the longitudinal axis 170.

The lower end 141 of the actuator 140 is disposed between the upper end 112 of the inner mandrel assembly 110 and the upper sealing element 153. The lower end 141 couples the inner mandrel assembly 110 through threads. Specifically, the inner surface 142 of the actuator 140 has threads 143 engaging with threads 114 on the surface 113 of the inner mandrel assembly 110, thus rotating the actuator 140 can make it move along the longitudinal axis 170 of the mandrel 100.

The upper sleeve 130 is employed to connect the actuator 140 and the upper sealing element 153. Similar to the lower sleeve 120, the upper sleeve 130 has two lugs 131, 132 projected from the inner surface thereof, the upper sealing element 153 has a slot 156 to engage the lug 131 while the outer surface of the actuator 140 has an annular groove 148 to accommodate the lug 132. In a preferred embodiment, the lug 132 has an annular shape to match the annular groove 148. The contact surface between the upper sealing element 153 and the actuator 140 is smooth. With this configuration, the upper sleeve 130 may connect the actuator 140 with the expandable sealing element 150 without limiting the rotation of the actuator 140.

In an embodiment, the expandable sealing element 150 is manufactured with an arch structure. That is, the outer diameters of the upper sealing element 153 and the lower sealing element 152 are smaller than that of the center sealing element 151, additionally, there is a gap 160 between the center sealing element 151 and the inner mandrel assembly 110. The gap 160 can provide space for the center sealing element 151 to shrink in radial direction when the expandable sealing element 150 is stretched.

The actuator 140 has a connector 149 on its upper end which can couple with a setting tool to rotate the actuator 140. In an embodiment, the setting tool of the present disclosure functions to engage with the connector 149 and drive the actuator 140 to rotate around the inner mandrel assembly 110.

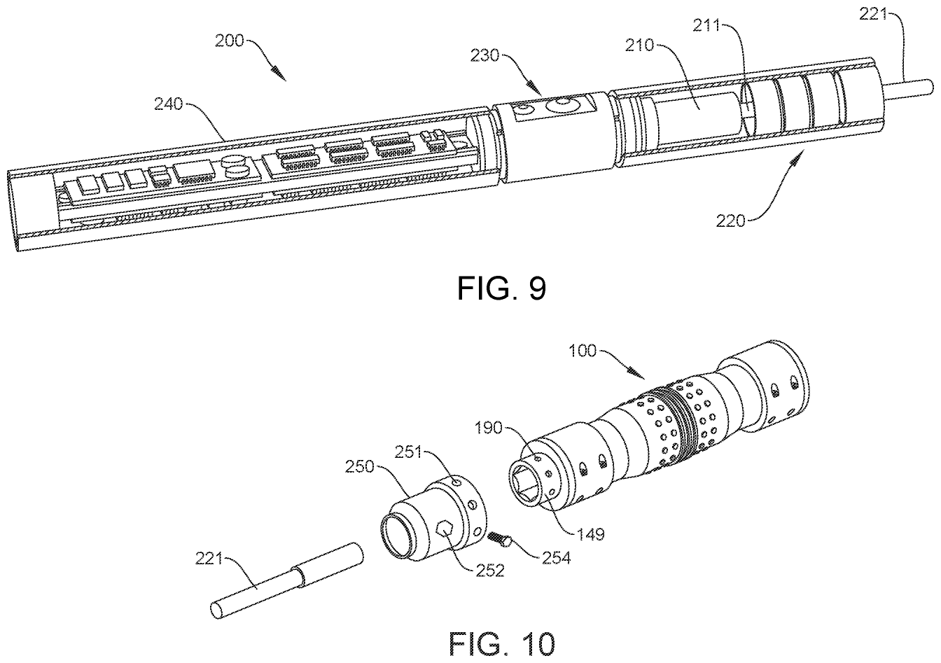

Referring to FIG. 9, a setting tool 200 of an embodiment include a motor 210 providing a rotary motion that will cause the packer system to stretch or compress. The motor can be either a downhole permanent magnet motor commonly used today in electric submersible pumping (ESP) systems or other efficient high-power motor capable of operating within a wireline conveyed environment, in order to drive and control the motor 210, the setting tool 200 further include a hydraulic compensator 230 and a power and control unit 240.

Current explosive or hydraulic setting tools (e.g., “Baker 20”) are commonly limited to <70,000 pounds of linear force. In the case of setting and retracting the isolation packer of the present disclosure, a much higher torque (approximately 10×) will be required. In order to increase torque as needed to pre-stretch and deform the isolation packer system, at least one gear reducer 220 can be used to trade speed for torque on the output shaft. In an embodiment, a maximum force of 700,000 pounds is needed to set and retract the isolation packer. This is a significant step-change (10×) to what the industry offers today. In this scenario, a set of gear reducer 220 comprising a plurality of gear reducers are connected in tandem to couple with the outpour shaft 211 of the motor 210 such that the torque on the output shaft 221 of the setting tool 200 can provide enough torque to drive the actuator 140 to set and retract the isolation packer. In a preferred embodiment, the number of the gear reducers 220 is three, The transmission ratio of the set of gear reducer 220 ranges from 10 to 1000.

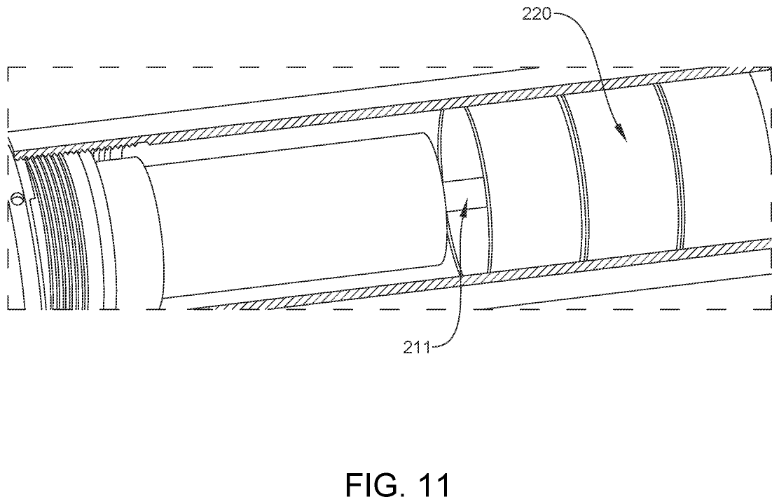

Referring to FIG. 10 and FIG. 11, the setting tool 200 further includes an adapter 250 on the bottom thereof. The adapter 250 can connect to the isolation packer 100 and transfer the force/torque such that the packer is stretched per requirement for run-in-hole. Once at depth, transfer the force/torque to the packer such that the packer stretch is relieved and additional compression is conveyed. At a specified level of torque/force, the setting tool 200 can be separated from the isolation packer 100. This adapter can then be modified (if needed) to ready for another run in the hole for isolation packer 100 retrieval. To this end, the adapter 250 should have the ability to provide a means to re-connect to the E-TIP while downhole (e.g., drop in and engage), transfer the force/torque to the packer such that the packer is stretched and maintain hold of the isolation packer 100 while pulling out of the hole.

The adapter 250 of the present disclosure can couple with the output shaft 221 on its up end and couple with the connector 149 of the isolation packer 100 on its lower end such that the torque on the setting tool 200 can be transmitted to the isolation packer 100. In an embodiment, the inner surface of the adapter 250 provide a plurality of detents 252 which can be coupled with the hex-shaped connector 149 in such manner that when the adapter rotates anticlockwise with respect to the connector 149, the adapter can be coupled with the connector 149 and transmit torque to the connector 149; when the adapter rotates clockwise with respect to the connector 149, the adapter will be decoupled from the connector 149 and cannot transmit torque to the connector 149. With this configuration, the adapter 250 has the ability to re-connect to the isolation packer 100 while downhole and transfer torque to the packer such that the packer is stretched and maintain hold of the isolation packer 100 while pulling out of the hole. The adapter 250 further includes a plurality of through holes 251 which can be aligned with corresponding holes 190 on the connector 149, such that a plurality of shear screws 254 engaged in the through holes (251, 190) of the adapter and holes on the connector 149, result in the connection between the setting tool 200 and the isolation packer 100. With this configuration, the adapter 250 has the ability to transfer torque to the packer such that the packer stretch is relieved and additional compression is conveyed. At a specified level of torque, the setting tool 200 can be separated from the isolation packer 100, which will be depicted in detail hereinafter.

The isolation packer system of the present disclosure utilizes a rotational motion and threaded connection from the setting tool to set and unset. This rotary setting tool can deliver extremely high forces, typically multiple times higher than current industry setting tool outputs.

The operational steps of the deploying and retrieving the isolation packer 100 can be described herein. Referring back to FIG. 3, in step A, the isolation packer 100 is originally manufactured an in a relaxed state, the outer diameter of the center sealing element 151 is similar to the inner diameter of a target wellbore casing 500. It is either slightly smaller than, equal to, or slightly larger than the wellbore casing 500.

Referring to FIG. 4, in step B, prior to run-in-hole, the setting tool 200 (not shown) is attached to the isolation packer 100 and the motor 210 drives the actuator 140 to rotate anticlockwise (operating in the reverse direction). The detents 254 in the adapter of the setting tool 200 will couple with the hex-shaped connector 149 of the actuator 140 and the actuator 140 will rotate anticlockwise and move outside along the longitudinal axis 170 of the inner mandrel assembly 110. This action will result in the expandable sealing element 150 of the isolation packer 100 being elastically stretched and the outer diameter of the center sealing element 151 being reduced with enough clearance to run-in-hole.

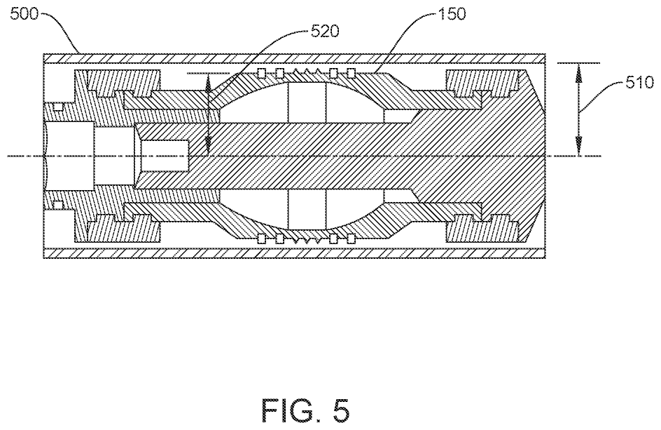

Referring to FIG. 5, in step C, during run-in-hole, the setting tool 200 (not shown) is attached to the isolation packer 100 through the adapter 250. In an embodiment, the shear screws are arranged into through holes of the adapter and holes on the connector 149 of the isolation packer 100 to connect the setting tool 200 and the isolation packer 100. The tension on the expandable sealing element 150 is maintained during run-in-hole. The outer diameter 520 of the center sealing element 151 is smaller than the inner diameter of the wellbore casing 500.

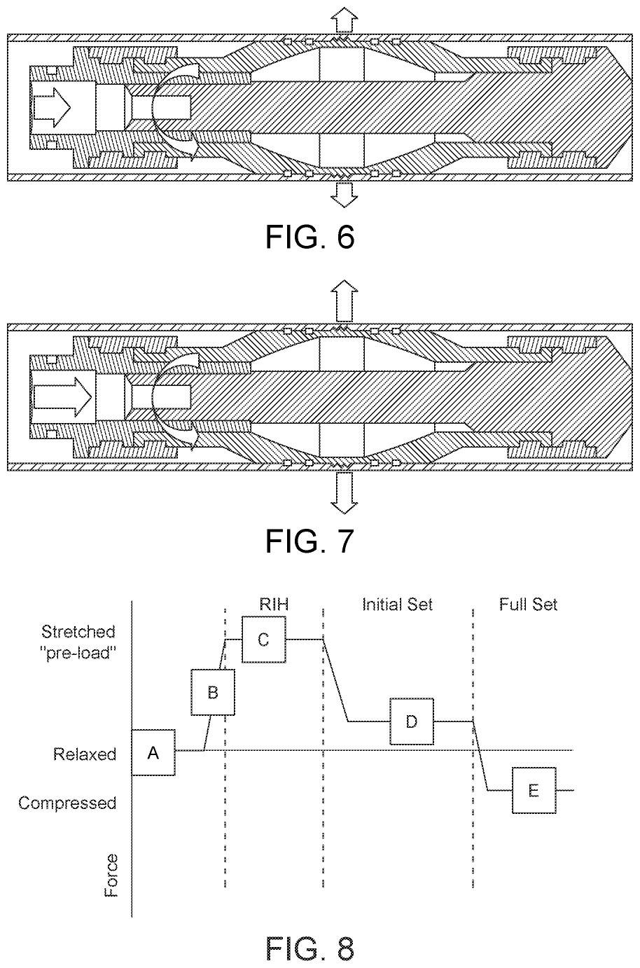

Referring to FIG. 6, in step D, once at a desired depth, the setting tool 200 (not shown) rotates clockwise (operating in the forward direction), the torque on the adapter 250 of the setting tool 200 transmits to the connector 149 of the isolation packer 100 through the shear screws and the actuator 140 will rotate clockwise and move inside along the longitudinal axis 170 of the inner mandrel assembly 110. The rotation releases the sleeve tension and allows the isolation packer 100 to nearly return to its original “relaxed” shape. In an embodiment, the center sealing element 151 interferes with the inner wall of the casing prior to full relaxation. This results with the isolation packer 100 obtaining an initial set. In another embodiment, the center sealing element 151 interferes with the inner wall of the casing after additional compression from the setting tool 200 is applied.

Referring to FIG. 7, in step E, the setting tool 200 continues to rotate in the forward direction, applying additional compressional forces on the isolation packer 100. This results in a higher setting pressure along the inner wall of the casing and puts the inner mandrel in tension for the duration of the set. When the torque increased to a specified level, the shear screws will be sheared and the setting tool 200 can then be separated from the isolation packer 100.

FIG. 8 illustrates torque vs. steps of the setting operation. In step A, the isolation packer 100 is in a relaxed state and the stretch force on the isolation packer 100 is zero. In step B, the expandable sealing element 150 of the isolation packer 100 is elastically stretched. In step C, during run-in-hole, the tension on expandable sealing element 150 is maintained. In step D, once at a desired depth, the tension is released and the isolation packer 100 nearly returns to its original relaxed shape. In step E, the isolation packer 100 is compressed such that the direction of force applied to the isolation packer 100 is reversed.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit, and scope of the disclosure. More specifically, it will be apparent that certain aspects which are related may be substituted for the aspects described herein while the same or similar results would be achieved. All such similar substitutes and modifications apparent to those skilled in the art are deemed to be within the spirit, scope and concept of the disclosure as defined by the appended claims.

What is claimed is:

1. An isolation system comprising:
an isolation packer comprising:
an inner mandrel; and
an expandable sealing element around the inner mandrel,
wherein the expandable sealing element is formed by integration of an upper sealing element, a center sealing element, and a lower sealing element, the center sealing element is located between the upper sealing element and the lower sealing element, the center sealing element has an outer diameter, the outer diameter in a relaxed state is larger than the outer diameter in a stretched state.

2. The isolation system of claim 1, wherein the isolation packer further comprising an actuator to stretch the expandable sealing element.

3. The isolation system of claim 2, wherein the actuator has threads engaging with the inner mandrel and moves along a longitudinal axis of the inner mandrel when rotating the actuator.

4. The isolation system of claim 2, wherein the isolation packer further comprising a lower sleeve and an upper sleeve rigidly connected to the expandable sealing element.

5. The isolation system of claim 4, wherein the lower sleeve connects the expandable sealing element to the inner mandrel, the upper sleeve connects the expandable sealing element to the actuator.

6. The isolation system of claim 5, wherein the actuator comprises a connector.

7. The isolation system of claim 6, wherein the connector comprises a plurality of first holes to receive shear screws.

8. The isolation system of claim 7, further comprising a setting tool for arranging the isolation packer to a casing.

9. The isolation system of claim 8, wherein the setting tool comprises:
a motor;
a set of gear reducer; and
an adapter with an ability to connect to the connector of the isolation packer.

10. The isolation system of claim 9, wherein the motor transmits a torque to the adapter through the set of gear reducer.

11. The isolation system of claim 9, wherein the adapter comprises a plurality of detents having ability to couple with the connector when the adapter rotate anticlockwise and to decouple from the connector when the adapter rotate clockwise.

12. The isolation system of claim 9, wherein the adapter comprises a plurality of second holes to receive the shear screws.

13. The isolation system of claim 9, wherein the set of gear reducer comprises three gear reducers.

14. The isolation system of claim 9, wherein the motor is a permanent magnet motor.

15. The isolation system of claim 1, wherein the expandable sealing element is formed of metal.

16. The isolation system of claim 15, wherein the expandable sealing element is metal with an arch structure.

17. The isolation system of claim 16, further comprising a gap between the center sealing element and the inner mandrel.

18. A method for arranging an isolation system 17, comprising:
providing an isolation packer in a relaxed state;
coupling via an adaptor and utilizing a setting tool to stretch an expandable sealing element prior to run-in-hole;
moving the isolation system down to a depth of a casing, then utilizing the setting tool to relax the expandable sealing element;
continuing to apply additional compressional force on the expandable sealing element until a seal is obtained; and
separating the setting tool from the expandable sealing element for retrieval of the setting tool.

19. The isolation system of claim 1, further comprising a plurality of teeth on a surface of the center sealing element.

20. The isolation system of claim 1, further comprising a plurality of sealing rings on a surface of the center sealing element.
